(19) United States
(12) Patent Application Publication
(10) Pub. No.: US 2012/0119991 A1
(43) Pub. Date: May 17, 2012

(54) 3D GESTURE CONTROL METHOD AND APPARATUS

(76) Inventors: Chi-Hung TSAI, Taichung City (TW); Yeh-Kuang WU, New Taipei City (TW); Bo-Fu LIU, Tainan City (TW); Chien-Chung CHIU, Luodong Township (TW); Hsiao-Chen CHANG, Taipei City (TW)

(21) Appl. No.: 13/189,771

(22) Filed: Jul. 25, 2011

(30) Foreign Application Priority Data
Nov. 15, 2010 (TW) 99139181

(51) Int. Cl. G06F 3/033

(52) U.S. Cl. 345/158

(57) ABSTRACT

A 3D gesture control method is provided. The method includes the steps of: obtaining a series of images by a stereo camera; recognizing a control article in the images and acquiring 3D coordinates of the control article; determining the speed of the control article according to the 3D coordinates of the control article; and operating a visible object according to the speed.

### CROSS REFERENCE TO RELATED APPLICATIONS

This Non-provisional application claims priority under 35 U.S.C. §119(a) on Patent Application No(s). 99139181, filed in Taiwan, Republic of China on Nov. 15, 2010, the entire contents of which are hereby incorporated by reference.

### BACKGROUND OF THE INVENTION

1. Field of the Invention

The present invention relates to gesture control methods and apparatuses, and in particular relates to gesture control methods and apparatuses using a 3D camera.

2. Description of the Related Art

FIG. 1 is a schematic diagram illustrating the gesture control system/apparatus of the prior art. The Gesture control system 100 of the prior art, such as a video game system, comprises a platform 110, a display 120 and a control article 130. The platform 110, usually disposed near the display 120, can be used to detect where the control article 130 held by a user points to. Therefore, the user can further control and interact with the objects in the video game shown by the displayer 120 through the platform 110, and thus have fun.

The gesture control system 10 in the prior merely detects whether the control article 130 is moving or the location of the control article 130, but does not detect the moving speed and moving range of the control article 130. In addition, users using the system of the prior art have to stay in a specific area for the platform 110 to efficiently detect the poses of the users, thus reducing maneuverability of the gesture control system in the prior art.

Therefore, a new gesture control system which can be controlled more freely and precisely is desirable.

### BRIEF SUMMARY OF THE INVENTION

The present invention provides a 3D gesture control method, which comprises the steps of: obtaining a series of images by a stereo camera; recognizing a control article in the images and acquiring 3D coordinates of the control article; determining the speed of the control article according to the 3D coordinates of the control article; and operating a visible object according to the speed.

The present invention further provides a 3D gesture control method, comprising the steps of: obtaining a series of images by a stereo camera; recognizing a control article in the images and acquiring 3D coordinates of the control article; determining the moving range of the control article according to the 3D coordinates of the control article; and operating a visible object according to the moving range.

The present invention further provides a 3D gesture control apparatus, which comprises: a stereo camera for obtaining a series of images, recognizing a control article in the images and acquiring 3D coordinates of the control article; and an image processing unit, coupled to the stereo camera, comprising: a movement determining unit for determining the speed of the control article according to the 3D coordinates of the control article; and a object controlling unit for operating a visible object according to the speed.

The present invention further provides a 3D gesture control apparatus, which comprises: a stereo camera for obtaining successive images, recognizing a control article in the images and acquiring 3D coordinates of the control article; and an image processing unit, coupled to the stereo camera, comprising: a movement determining unit for determining the moving range of the control article according to the 3D coordinates of the control article; and an object controlling unit for operating a visible object according to the moving range.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating the gesture control system/apparatus of the prior art;

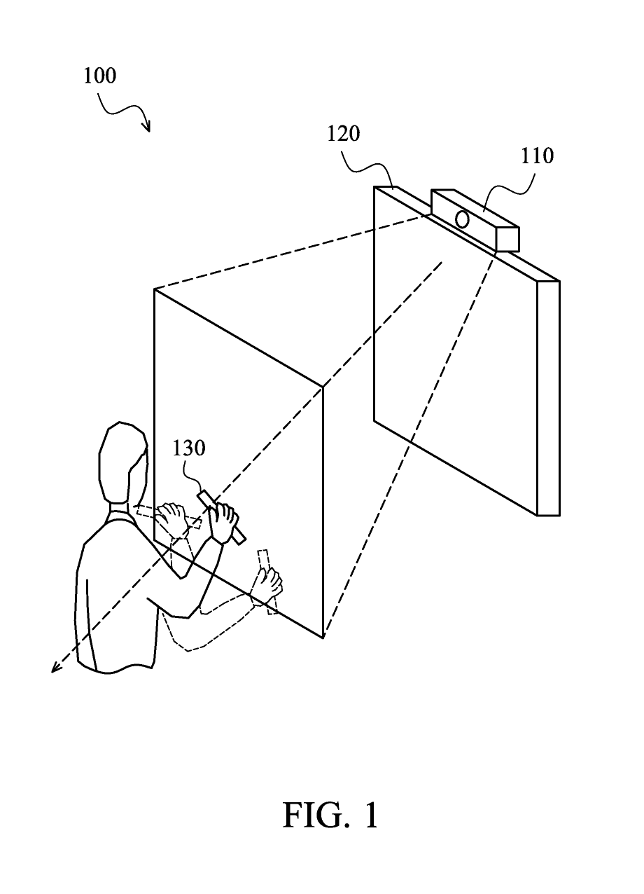

FIG. 2 is a flowchart of the 3D gesture control method according to one embodiment of the present invention; and

FIG. 3 is a schematic diagram of the 3D gesture control apparatus according to one embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

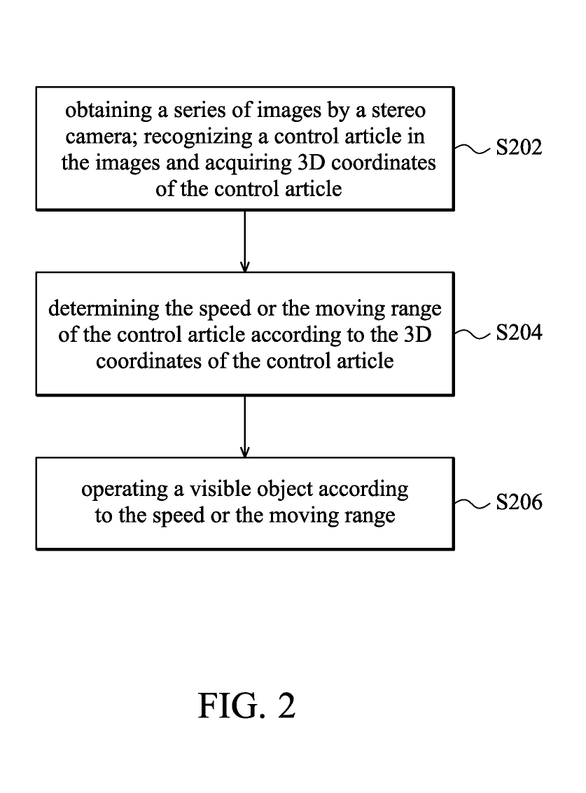

FIG. 2 is a flowchart of the 3D gesture control method according to one embodiment of the present invention. The 3D gesture control method in the present invention comprises: in step S202, obtaining a series of images by a stereo camera; recognizing a control article in the images and acquiring 3D coordinates of the control article; in step S204, determining the speed or the moving range of the control article according to the 3D coordinates of the control article; and in step S206, operating a visible object according to the speed or the moving range.

In one embodiment, the 3D gesture control method can be used in the video game system described in the related art. With the 3D gesture control method, users can operate various objects shown in a display of the video game system, such as a menu, a button, or an avatar (virtual character). For example, the object may be the drumstick in a virtual drumming video game or a basketball in a virtual basketball video game. In another embodiment, the object may also be a multimedia picture (such as film, commercial, or animation pictures), a software interface (such as Powerpoint, web pages, application interfaces), or virtual reality. Note that in other embodiments, the 3D gesture control method can also be used on human machine interface for controlling real objects such as machines or robots. The objects described above all belong to the so-called visible objects of step S206. Since the visible objects can be moved and the movement of the visible objects can be seen by the users at the same time, interaction between the object and the users can be established.

In step S202, the present invention obtains a series of images by a stereo camera, recognizes a control article in the images and acquires 3D coordinates of the control article. In this embodiment, the control article can be part of a user's body, such as the head, palms or feet of a user, or objects held by or worn on the user, such as bottle, baton or helmet objects. The stereo cameras may be two cameras or any depth camera using infrareds or lasers to obtain the spatial coordinates of the control article. In some embodiments, the cameras can be disposed around or integrated with the display in order to obtain the spatial coordinates of the control article right in front of the display and the cameras. The spatial coordinates includes not only the 2D information (x and y coordinates) but also the depth information. In other embodiments, the number and the disposition of the cameras are not limited thereto.

In step S202, the present invention can use various techniques, such as Template matching method, Pattern model normalization method, Edge Detecting method, image classification method, Linear feature extraction method, Dominant Color Extraction and Similarity method, to recognize the control article from the images obtained by the stereo camera. Through the depth information and an image extracting technique, the present invention can analyze the images to acquire at least one foreground object and the 3D coordinates of the at least one foreground object and to determine the speed of the at least one foreground object. When a plurality of foreground objects are acquired, the method can determine the highest speed one as the control article. If only one foreground object is acquired, this one is determined as the control article. In another embodiment, the present invention can analyze the images to acquire at least one foreground object and the 3D coordinates of the at least one foreground object. When a plurality of foreground objects are acquired, the present invention can determine the forefront one as the control article. If only one foreground object is acquired, this one is determined as the control article. For example, when a user whose image is in the stereo image moves his palm rapidly or moves his palm in front of his body, the present invention will determine the palm as the control article. Those skilled in the art can further establish appropriate rules for recognizing the features of the control article by using the image characteristic acquisition and comparison technique, such as providing a control article database. For example, the control article can be determined when it's image in the 2D images obtained by the stereo cameras/two cameras can be recognized and be corresponding to the features stored in the control article database when performing comparison. For another example, a user can move a particular object (e.g., a hand) into a “virtual frame” added onto a 2D image shown by a display to refer to the particular object as the control article.

In step S204, the present invention determines the speed or the moving range of the control article according to the 3D coordinates of the control article. The control article can be moved along a trajectory by the user. The present invention can calculate the speed or the moving range of the control article based on the 3D coordinates of the points on the trajectory of the control article and the time that the control article expends when moving from one point to another point. Note that the “speed” here means the “actual speed” of the control article moving in a 3D space, but does not mean the virtual speed of the control article moving in the images. Owning to lack of depth information of z coordinates, the prior art method merely determines the 2D motions (displacement and speed in x and y direction) of the control article in the images shot by a camera. Thus, for a same movement, the control article of the prior art moving in a place closer to the camera will be determined as having a higher speed and greater moving range than that in a place further away from the camera. In other words, the speed/moving range of the control article determined by the prior art method are not consistent and dependent on where the control article is placed. Thus, in the prior art, users with the same operation but different distances from the camera can not control the visible object in the same manner Since the present invention can measure the z coordinates of the control article, the inconsistencies of the speed/moving range due to the distance between the control article and the camera can be calibrated. It should be noted that the visible object can not be operated according to the speed or range of the object moving in a z direction in the prior art method. The present invention can determine the speed and range of the control article moving in a z direction by using a stereo camera, thus controlling the visible object according thereto.

The present invention can extract meaningful part from the trajectory of the control article according to the purpose of control. For example in a sports game, a player usually moves their body or parts of their body to-and-fro (for example, waving left and right, punching out and pulling in, etc.), and it is not necessary for the game to track all trajectory for every movement made by the player (such as in a virtual basketball game, the movement of hands after shooting sometimes can be ignored). In other words, different games may focus on different parts of the movement trajectories of players according to their game property. For example, since the main movement trajectory in the said virtual basketball game is shooting a basketball forwards in a parabolic curve (that mean the meaningful part from the trajectory of the control article is that the control article moves forwards and from upward to downward), the present invention only needs to focus on the trajectory of the control article in up-and-down direction (such as in Y direction) and in forward and backward direction (such as in Z direction).

In another embodiment, when the movements of the control article is complex, the present invention can further determine whether the trajectory of the control article is classified into one of various types, and when the trajectory of the control article is determined as a specific type, the present invention can operate the visible object in accordance with the specific type of the trajectory of the control article. For example, the present invention, by using fuzzy neural technique, can establish two kinds of trajectory classifiers, where one is a circular trajectory classifier and the other one is a linear trajectory classifier, for determining whether the moving trajectory of the control article is a circular trajectory or a linear trajectory. When the moving trajectory is determined as a circular path, the present invention focuses the 3D rotation speed and moving range of the control article; and when the moving trajectory is determined as a linear path, the present invention focuses the 3D speed and moving range along straight lines. The classifier of the present invention can establish other secondary fuzzy rules to further classify the paths into subtypes. The trajectory classification technique is not the subject of the present invention and will not be further discussed.

In step S206, the present invention further controls a visible object according to the speed or the moving range of the control article. In an embodiment, the speed or the moving range of the visible object is determined according to the speed or the moving range of the control article. In another embodiment, the trajectories of the control article which correspond to various control functions can be defined in advance. For example, the clockwise circular moving trajectory may mean “fast forwarding”, and the counter clockwise circular moving trajectory may mean “reversing” in multimedia playing; and the faster the circular moving trajectory is, the faster the “fast forwarding” or the “reversing” For another example, the higher speed of the control article may correspond to greater power in a video game.

By using the present invention, users do not have to stay in a specific area for operating the visible object by the control article, and do not have to worry about the distance and the direction between the control article and the camera. Since the same movements will lead to the same controls, the present invention improves upon the feasibility and precision of gesture control.

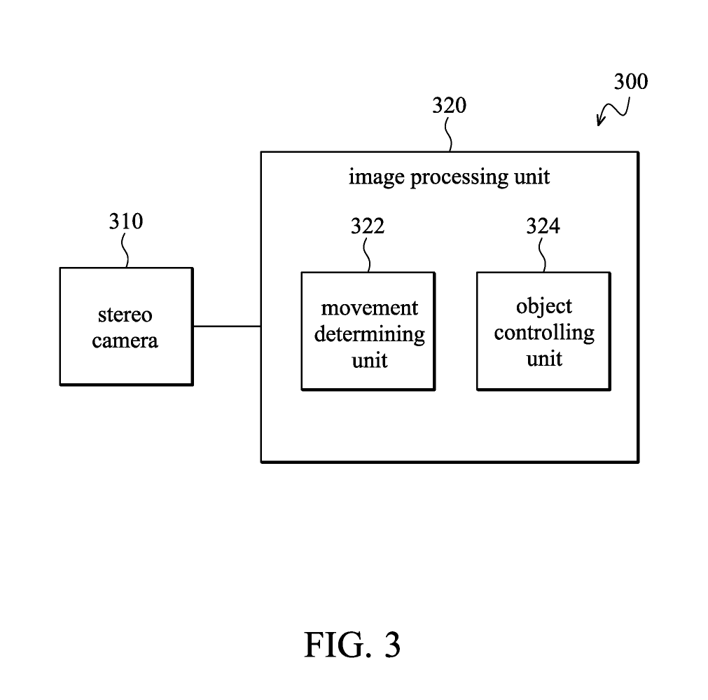

In addition to the 3D gesture control method, the present invention further provides a 3D gesture control apparatus. FIG. 3 is a schematic diagram of the 3D gesture control apparatus according to one embodiment of the present invention. The 3D gesture control apparatus 300 comprises a stereo camera 310 and an image processing unit 320 coupled to the stereo camera 310. The image processing unit 320 comprises a movement determining unit 322 and object controlling unit 324. The stereo camera 310 is used for obtaining a series of images, recognizing a control article in the images, and acquiring 3D coordinates of the control article. Similarly, the control article can be part of a user's body, such as the head, palms or feet of a user, or objects held by or worn on the user, such as bottle, baton or helmet objects. The stereo cameras may be two cameras or any active depth stereo camera using infrareds or lasers to obtain the spatial coordinates of the control article. The movement determining unit 322 is used for determining the speed or the moving range of the control article according to the 3D coordinates of the control article. The object controlling unit 324 is used for operating a visible object according to the speed or the moving range determined. The 3D gesture control apparatus 300 may further comprises a classifier (not shown), coupled to the image processing unit 320 for determining whether the trajectory of the control article is classified into one of various types. Therefore, the object controlling unit 324 may control the visible object according to the type of the trajectory classified by the classifier.

Since the 3D gesture control apparatus 300 can perform the steps S202-S206 of the 3D gesture control method described previously and achieve the same purpose, embodiments of the 3D gesture control apparatus 300 will not be further discussed for brevity.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A 3D gesture control method, comprising the steps of:
obtaining a series of images by a stereo camera;
recognizing a control article in the images and acquiring 3D coordinates of the control article;
determining the speed of the control article according to the 3D coordinates of the control article; and
operating a visible object according to the speed.

2. The 3D gesture control method as claimed in claim 1, wherein the step of recognizing the control article in the images further comprises:
analyzing the images to acquire at least one foreground object and the 3D coordinates of the at least one foreground object and to determine the speed of the at least one foreground object; and
determining the highest speed one as the control article when a plurality of the foreground objects are acquired.

3. The 3D gesture control method as claimed in claim 1, wherein the step of recognizing the control article in the images further comprises:
analyzing the images to acquire at least one foreground object; and
determining the forefront one as the control article when a plurality of the foreground objects are acquired.

4. The 3D gesture control method as claimed in claim 1, wherein the step of determining the speed of the control article according to the 3D coordinates of the control article further comprises:
calculating the speed of the control article based on the 3D coordinates of the points in the trajectory of the control article and the time that the control article moves from point to point.

5. The 3D gesture control method as claimed in claim 1, further comprising:
determining whether the trajectory of the control article is classified into one of various types; and
operating the visible object in accordance with the type of the trajectory of the control article.

6. The 3D gesture control method as claimed in claim 1, wherein the visible object is an object displayed in a displaying picture.

7. The 3D gesture control method as claimed in claim 1, wherein the visible object is a real object able to be controlled by a human machine interface.

8. A 3D gesture control apparatus, comprising:
a stereo camera for obtaining a series of images, recognizing a control article in the images and acquiring 3D coordinates of the control article; and
an image processing unit, coupled to the stereo camera, comprising:
a movement determining unit for determining the speed of the control article according to the 3D coordinates of the control article; and
a object controlling unit for operating a visible object according to the speed.

9. The 3D gesture control apparatus as claimed in claim 8, wherein the images are analyzed to acquire at least one foreground objects and the 3D coordinates of the at least one foreground objects and to determine the speed of the foreground objects, and the highest speed one is determined as the control article when a plurality of the foreground objects are acquired.

10. The 3D gesture control apparatus as claimed in claim 8, wherein the images are analyzed to acquire at least one foreground object, and the forefront one is determined as the control article when a plurality of the foreground objects are acquired.

11. The 3D gesture control apparatus as claimed in claim 8, wherein the speed of the control article is calculated based on the 3D coordinates of the points in the trajectory of the control article and the time that the control article moves from point to point.

12. The 3D gesture control apparatus as claimed in claim 8, further comprising:
a classifier, coupled to the image processing unit, for determining whether the trajectory of the control article is classified into one of various types, wherein the visible object is operated in accordance with the type of the trajectory of the control article.

13. A 3D gesture control method, comprising the steps of:
obtaining a series of images by a stereo camera;
recognizing a control article in the images and acquiring 3D coordinates of the control article;
determining the moving range of the control article according to the 3D coordinates of the control article; and
operating a visible object according to the moving range.

14. A 3D gesture control apparatus, comprising:
a stereo camera for obtaining successive images, recognizing a control article in the images and acquiring 3D coordinates of the control article; and
an image processing unit, coupled to the stereo camera, comprising:
a movement determining unit for determining the moving range of the control article according to the 3D coordinates of the control article; and
an object controlling unit for operating a visible object according to the moving range.
